(19) United States
(12) Patent Application Publication
(10) Pub. No.: US 2025/0096921 A1
(43) Pub. Date: Mar. 20, 2025

(54) IFoF SCHEME OPTICAL TRANSMISSION SYSTEM

(71) Applicant: Mitsubishi Electric Corporation, Tokyo (JP)

(72) Inventors: Junya NISHIOKA, Tokyo (JP); Yoshiaki KONISHI, Tokyo (JP)

(73) Assignee: Mitsubishi Electric Corporation, Tokyo (JP)

(21) Appl. No.: 18/968,392

(22) Filed: Dec. 4, 2024

Related U.S. Application Data
(63) Continuation of application No. PCT/JP2022/027335, filed on Jul. 12, 2022.

(51) Int. Cl. H04J 14/02; H04J 1/05

(52) U.S. Cl. CPC H04J 14/0256; H04J 1/05; H04J 14/0307

(57) ABSTRACT

An IFoF scheme optical transmission system according to the present disclosure technology includes a transmission-side digital signal processor including a system number compressor; and a parameter updater, the system number compressor compressing n digital data streams into m digital data streams, m being smaller than n, and the parameter updater updating a parameter used by the system number compressor by referring to a value of an evaluation function using a signal string handled by the transmission-side digital signal processor as an argument.

### CROSS REFERENCE TO RELATED APPLICATION

This application is a Continuation of PCT International Application No. PCT/JP2022/027335, filed on Jul. 12, 2022, which is hereby expressly incorporated by reference into the present application.

### TECHNICAL FIELD

The present disclosure technology relates to an IFoF scheme optical transmission system.

### BACKGROUND ART

An optical transmission system is a transmission system in which light is used as a signal transmission means in place of electromagnetic waves used in televisions and radios. In the optical transmission system, an optical fiber is generally used as a medium that propagates light. Therefore, a scheme of the optical transmission system is distinguished from a method in which light is emitted toward the atmosphere to propagate through the air. As a light source in the optical transmission system, for example, a semiconductor laser or a light emitting diode is used. In the optical transmission system, a light intensity modulation scheme of transmitting a signal in accordance with on-off of laser light or a coherent optical communication scheme of modulating a frequency or a phase of laser light in accordance with the signal is adopted.

The optical transmission system is expected as a transmission system of a next-generation mobile network.

As a method for implementing a mobile fronthaul (MFH) of a centralized radio access network (C-RAN) considered to be promising in the next-generation mobile network, there are a digital radio-over-fiber (D-RoF) and an analog radio-over-fiber (A-RoF).

The A-RoF has an advantage that analog waveforms of radio signals are transmitted as they are, so that a signal quality in an MFH operation is maintained without requiring much less optical transmission bandwidth than that of the D-RoF. On the other hand, by using a high-performance digital signal processor (DSP), multiplexing and demultiplexing of intermediate frequencies (IFs) can be implemented by digital signal processing. The digital signal processing by the high-performance DSP enables highly efficient and flexible transmission by dense frequency arrangement. The digital signal processing by the high-performance DSP makes it possible to cluster a plurality of channels and multiplex and demultiplex a plurality of clusters.

By combining multiplexing and demultiplexing by these DSPs with the A-RoF, it is possible to perform frequency multiplexing of a plurality of radio signals in an intermediate frequency band (IF band) and collectively transmit to an antenna by one optical fiber and one wavelength by analog optical modulation. This optical fiber radio technology is sometimes referred to as an intermediate frequency over-fiber (IFoF) scheme.

For example, Patent Literature 1 discloses an A-RoF solution in which a plurality of different IF signals is frequency-multiplexed and transmitted by the A-RoF in radio signal transmission between a base band unit (BBU) and a remote radio head (RRH) (refer to [0004] and [0005], and FIGS. 2A and 2B of Patent Literature 1). In Patent Literature 1, the A-RoF solution is referred to as “A-RoF solution with ADC/DAC and IF multiplexer/demultiplexer”, and a schematic configuration thereof is illustrated in FIG. 2B of Patent Literature 1.

### CITATION LIST

### Patent Literature

Patent Literature 1: JP 2020-5303 A

### SUMMARY OF INVENTION

### Technical Problem

In the optical transmission system by the A-RoF solution, it is desired to increase the number of signal channels as much as possible, but the number is limited.

An object of the present disclosure technology is to effectively use a finite number of signal channels included in a transmission system.

### Solution to Problem

An IFoF scheme optical transmission system according to the present disclosure technology includes a transmission-side digital signal processor including a system number compressor and a parameter updater, and a reception-side digital signal processor including a system number restorer, wherein, the system number compressor compresses n digital data streams into m digital data streams, m being smaller than n, and the parameter updater updates a parameter used by the system number compressor by referring to a value of an evaluation function using a signal string handled by the transmission-side digital signal processor as an argument, the system number restorer restores n digital data streams compressed into m digital data streams by referring to the parameter updated by the parameter updater, the parameter updated by the parameter updater is a matrix (W^{H}) having a size of m×n and a matrix (W) obtained by performing Hermitian transpose on the matrix (W^{H}).

### Advantageous Effects of Invention

Since the optical transmission system according to the present disclosure technology has the above-described configuration, this can effectively use a finite number of signal channels included in the transmission system.

### BRIEF DESCRIPTION OF DRAWINGS

FIG. 1 is a block diagram illustrating a functional configuration on a transmission side of an optical transmission system according to a first embodiment.

FIG. 2 is a block diagram illustrating a functional configuration on a reception side of the optical transmission system according to the first embodiment.

FIG. 3 is a block diagram illustrating a detailed function of a frequency-division multiplexing unit 120 included in a transmission-side digital signal processing device 100 according to the first embodiment.

FIG. 4 is a block diagram illustrating a detailed function of a frequency-division demultiplexing unit 610 included in a reception-side digital signal processing device 600 according to the first embodiment.

FIG. 5 is a block diagram illustrating a functional configuration on a transmission side of an optical transmission system according to a second embodiment.

FIG. 6 is a block diagram illustrating a functional configuration on a transmission side of an optical transmission system according to a third embodiment.

FIG. 7 is a block diagram illustrating a functional configuration on a reception side of the optical transmission system according to the third embodiment.

FIG. 8 is a block diagram illustrating a functional configuration on a transmission side of an optical transmission system according to a fourth embodiment.

FIG. 9 is a block diagram illustrating a functional configuration on a reception side of the optical transmission system according to the fourth embodiment.

FIGS. 10A and 10B are hardware configuration diagrams of a transmission-side digital signal processing device 100 according to a fifth embodiment.

FIGS. 11A and 11B are hardware configuration diagrams of a reception-side digital signal processing device 600 according to the fifth embodiment.

### DESCRIPTION OF EMBODIMENTS

### First Embodiment

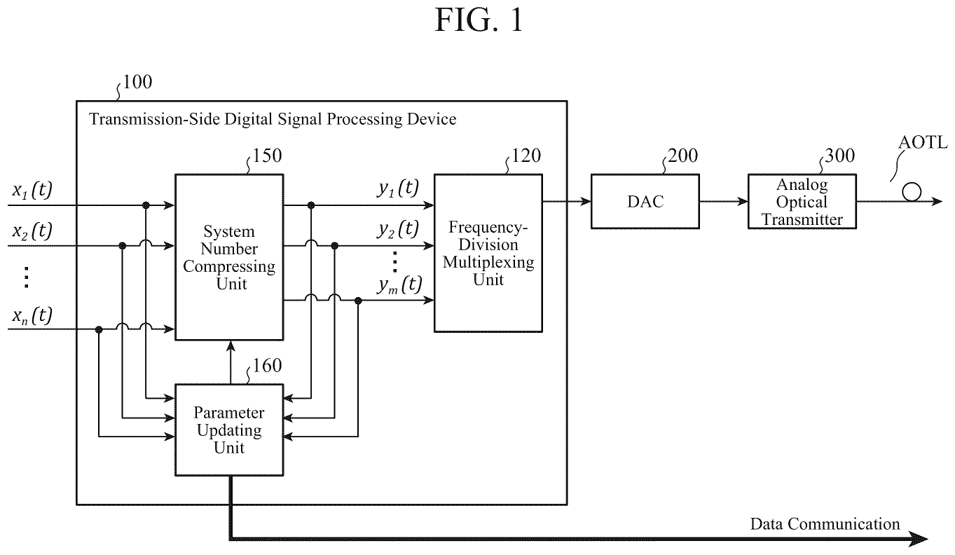

FIG. 1 is a block diagram illustrating a functional configuration on an optical transmission side (hereinafter, simply referred to as a “transmission side”) of an optical transmission system according to a first embodiment. As illustrated in FIG. 1, the optical transmission system according to the first embodiment includes, on the transmission side, a transmission-side digital signal processing device 100, a DAC 200, and an analog optical transmitter 300. As illustrated in FIG. 1, the transmission-side digital signal processing device 100 includes a frequency-division multiplexing unit 120, a system number compressing unit 150, and a parameter updating unit 160. The transmission side of the optical transmission system may be considered as, for example, an A-RoF optical subscriber line terminal device.

### Frequency-Division Multiplexing Unit 120 Included in Transmission-Side Digital Signal Processing dDevice 100

The frequency-division multiplexing unit 120 included in the transmission-side digital signal processing device 100 is a component that multiplexes m signal strings (y₁(t), y₂(t), . . . , and yₘ(t)). Multiplexing is sometimes referred to as multiplexer processing, Multiplexing, or referred to as Muxing for short. A device that performs multiplexing (Muxing) in an intermediate frequency (IF) is sometimes described as an IF-MUX. Processing performed by the IF-MUX is sometimes described as IF-MUX processing. More specifically, the frequency-division multiplexing unit 120 combines digital data streams related to the m signal strings (y₁(t), y₂(t), . . . , and yₘ(t)) into one, and enables transmission of the same to an optical reception side (hereinafter, simply referred to as a “reception side”) via one shared analog optical transmission line (AOTL). The analog optical transmission line (AOTL) includes, for example, an optical fiber.

Although signals handled by the transmission-side digital signal processing device 100 are digital signals, the m signal strings are described as y₁(t), y₂(t), . . . , and yₘ(t). The signal handled by the frequency-division multiplexing unit 120 is described as if this is an analog signal as a function of time t. There is a reason for this description. This is because the transmission-side digital signal processing device 100 is implemented by a high-performance DSP, and this indicates that the transmission-side digital signal processing device 100 can handle an input signal as if this handles the analog signal.

The signal multiplexed by the frequency-division multiplexing unit 120 is transmitted to the DAC 200.

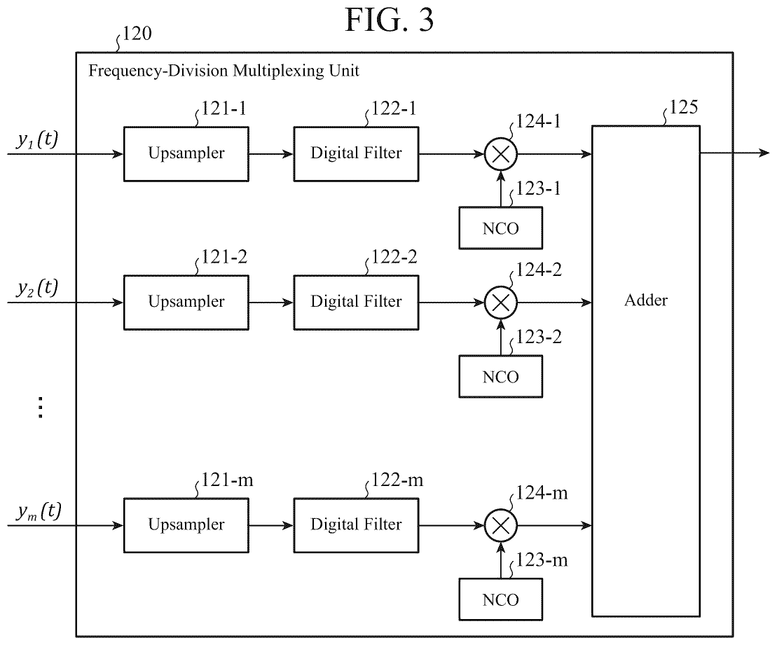

FIG. 3 is a block diagram illustrating a detailed function of the frequency-division multiplexing unit 120 included in the transmission-side digital signal processing device 100 according to the first embodiment. As illustrated in FIG. 3, the frequency-division multiplexing unit 120 includes the digital data streams related to the m signal strings (y₁(t), y₂(t), . . . , and yₘ(t)). As illustrated in FIG. 3, each digital data stream includes, for example, an upsampler 121, a digital filter 122, an NCO 123, and a multiplier 124. A functional block related to a first digital data stream is distinguished by adding “-1” after the reference numerals such as an upsampler 121-1, a digital filter 122-1, an NCO 123-1, and a multiplier 124-1. In the present specification, functional blocks related to other digital data streams are also distinguished by similar reference numerals.

The upsampler 121 in the digital data stream performs sampling depending on a rate of the DAC 200. Specifically, the upsampler 121 performs, for example, zero (0) interpolation, increases a sampling rate, and implements the sampling depending on the rate of the DAC 200.

The signal strings (y₁(t), y₂(t), . . . , and yₘ(t)) on which the upsampler 121 performs the sampling may be a complex signal of an input frequency centered at zero (0) [Hz] or a real signal.

The digital filter 122 in the digital data stream removes an unnecessary image signal generated in the upsampler 121.

The NCO 123 in the digital data stream generates a data string of a predetermined frequency for each digital data stream. For example, the NCO 123-1 generates a data string of a frequency f₁, and the NCO 123-2 generates a data string of a frequency f₂. The name of the NCO 123 is derived from an acronym of a numerically controlled oscillator, and means a numerically controlled oscillator.

It is assumed that i is a variable taking a natural number from 1 to m, and the frequency of the data string generated by an NCO 123-i in an i-th digital data stream is fᵢ. In the present specification, fᵢ is referred to as an “i-th NCO frequency”.

The data string generated by the NCO 123-i may be a complex number or a real number. That is, the processing performed by the frequency-division multiplexing unit 120 may be in a complex domain or a real number domain. In a case where the processing performed by the frequency-division multiplexing unit 120 is in the complex domain, any one of a real part and an imaginary part of the obtained complex number is selected and used as an output of the DAC 200.

The multiplier 124 in the digital data stream multiplies an output from the digital filter 122 by an output from the NCO 123. More specifically, a multiplier 124-i in the i-th digital data stream multiplies an output from a digital filter 122-i by an output from an NCO 123-i. Multiplying the NCO frequency (fᵢ) means shifting in the frequency domain by the NCO frequency (fᵢ), that is, frequency shifting.

An adder 125 in the frequency-division multiplexing unit 120 adds frequency-shifted signals of the respective digital data streams. A signal obtained by adding by the adder 125 is referred to as a multiplexed signal.

In FIG. 3, a configuration in which the m signal strings (y₁(t), y₂(t), . . . , and yₘ(t)) are processed in parallel is illustrated, but the present disclosure technology is not limited thereto. The frequency-division multiplexing unit 120 may perform the signal processing not in parallel (parallel) but in series (series), that is, in multiple stages.

### System Number Compressing Unit 150 Included in Transmission-Side Digital Signal Processing Device 100

The system number compressing unit 150 included in the transmission-side digital signal processing device 100 is a component that compresses n (n>m) digital data streams into m digital data streams. Specifically, the system number compressing unit 150 performs processing given by the following mathematical expression.

$${\overbrace{[ \begin{matrix}{y}_{1} ( t ) \\ {y}_{2} ( t ) \\ ⋮ \\ {y}_{m} ( t )\end{matrix} ]}}^{\vec{y} ( t )} = {W}^{H} {\overbrace{[ \begin{matrix}{x}_{1} ( t ) \\ {x}_{2} ( t ) \\ ⋮ \\ {x}_{n} ( t )\end{matrix} ]}}^{\vec{x} ( t )} \qquad ( 1 )$$

$$wherein$$

$$m < n$$

Note that, a matrix W^{H} appearing in Expression (1) is a matrix having a size of m×n and is given by the parameter updating unit 160. Superscript H in the matrix WH represents Hermitian transpose. Details of the matrix W^{H} will be apparent by the following description.

### Parameter Updating Unit 160 Included in Transmission-Side Digital Signal Processing Device 100

The parameter updating unit 160 included in the transmission-side digital signal processing device 100 is a component that updates a parameter used by the system number compressing unit 150. Specifically, the parameter updating unit 160 updates a matrix W appearing in Expression (1).

The matrix W^{H} that performs mapping to compress the system number is determined in order to minimize an evaluation function (V) given by the following expression.

$$V ( \vec{x} ( t ) ) := E \{ {‖ \vec{x} ( t ) − {WW}^{H} \vec{x} ( t ) ‖}^{2} \} \qquad ( 2 )$$

Note that, E of a function appearing in Expression (2) represents an expected value. A symbol “∥ ∥” appearing in Expression (2) represents a norm such as a Euclidean norm. The matrix W is given by the following expression.

$$W = {argmin}_{W} E \{ ‖ \vec{x} ( t ) − {WW}^{H} v = \vec{x} ( t ) {‖}^{2} \} \qquad ( 3 )$$

As described above, the matrix W^{H} is the matrix having the size of m×n, and performs the mapping to compress the system number. In contrast, the matrix W appearing in Expressions (2) and (3) is a matrix having a size of n×m. The matrix W is a matrix used in a system number restoring unit 650 to be described later, and acts to restore the system number from m to n.

The evaluation function (V) appearing in Expression (2) is an evaluation function designed to compare an original signal string x(t) with a compressed and restored signal string WW^{H}x(t) and obtain the matrix W having the smallest difference therebetween.

The original signal string x(t) is n-dimensional, but when a space defined by x(t) when a time t is changed is m-dimensional (m<n), the matrix W^{H} is given as a mapping from an n-dimensional space to an m-dimensional partial space defined by x(t).

Even when the space defined by x(t) when the time t is changed is of a dimension higher than the m-dimension, the matrix W^{H} performs mapping to the m-dimensional partial space while reducing the dimension with less influence in such a manner that the difference between the original signal string x(t) and the compressed and restored signal string WW^{H}x(t) does not become large.

In this manner, the matrix WH performs the mapping from the n-dimensional space to the m-dimensional partial space. On the contrary, the matrix W performs the mapping from the m-dimensional partial space to the n-dimensional space. As expressed by Expressions (2) and (3), the optical transmission system according to the present disclosure technology updates the matrix W in such a manner that the matrix W becomes an inverse mapping of the matrix WH.

Since the optical transmission system according to the present disclosure technology updates the matrix W and the matrix W^{H} by referring to the original signal string x(t) in this manner, this can be said to be an adaptive optical transmission system.

The parameter updating unit 160 may update the matrix W using a vector for intermediate calculation (hₖ) given by the following expression.

$${\vec{h}}_{k} = {P}_{k} {\vec{y}}_{k} \qquad ( 4 )$$

Here, subscript k used in Expression (4) represents a k-th sampling time. In Expression (4), yₖ represents the same signal as y(t) appearing in Expression (1). A matrix Pₖ appearing in Expression (4) is referred to as an estimation matrix, and is updated by an updating rule expressed by the following expression.

$$\begin{matrix} & {P}_{k + 1} = \frac{1}{β} Tri \{ {P}_{k} − {\vec{g}}_{k} {( {\vec{h}}_{k} )}^{H} \}\end{matrix} \qquad ( 5 )$$

$$wherein$$

$${\vec{g}}_{k} = \frac{{\vec{h}}_{k}}{β + {( {\vec{y}}_{k} )}^{H} {\vec{h}}_{k}}$$

Note that, matrix calculation Tri appearing in Expression (5) represents an operation of first calculating a lower triangular portion and copying Hermitian transpose of the lower triangular portion to an upper triangular portion. In addition, β appearing in Expression (5) represents a forgetting parameter that determines an updating degree (updating speed), and takes a value larger than 0 and equal to or smaller than 1.

Finally, the matrix W is updated according to the updating rule expressed by the following expression.

$${W}_{k + 1} = {W}_{k} − {\vec{e}}_{k} {( {\vec{g}}_{k} )}^{H} \qquad ( 6 )$$

$$wherein$$

$${\vec{e}}_{k} = {\vec{x}}_{k} - {W}_{k} − {\vec{y}}_{k}$$

Here, eₖ appearing in Expression (6) represents an error vector.

The parameter updating unit 160 may perform the update of the matrix W not every sampling but at constant intervals. In a case where the parameter updating unit 160 updates the matrix W, for example, every L sampling, the updating rule of an updating matrix (P) and the matrix W is given as expressed in the following expression.

$$\{ \begin{matrix}if k + 1 ≡ 0 ( mod L ) & \{ \begin{matrix}{P}_{k + 1} = \frac{1}{β} Tri \{ {P}_{k + 1 − L} − {{\vec{g}}_{k + 1 − k} ( {\vec{h}}_{k + 1 − k} )}^{H} \} \\ {W}_{k + 1} = {W}_{k + 1 − L} + {\vec{e}}_{k + 1 − k} {( {\vec{g}}_{k + 1 − 1} )}^{H}\end{matrix} \\ else & \{ \begin{matrix}{P}_{k + 1} = {P}_{k} \\ {W}_{k + 1} = {W}_{k}\end{matrix}\end{matrix} \qquad ( 7 )$$

The update of the matrix W at constant intervals in this manner is intended to update the updating matrix (P) and the matrix W for each total latency in consideration of an arithmetic processing capability of the transmission-side digital signal processing device 100.

### DAC 200

The DAC 200 is a component that converts a digital signal into an analog signal. The DAC in the name of the DAC 200 is an acronym of a digital-to-analog converter. The signal converted into analog by the DAC 200 is transmitted to the analog optical transmitter 300.

### Analog Optical Transmitter 300

The analog optical transmitter 300 is a component that converts an electrical analog signal transmitted from the DAC 200 into an optical signal and transmits the same to the analog optical transmission line (AOTL). That is, the analog optical transmitter 300 is an electrical-to-optical converter (EOC). The analog optical transmitter 300 is implemented by, for example, an electro-absorption modulator laser (EML). The EML is a semiconductor laser in which an electric field absorption type optical modulator for converting an electrical signal into an optical signal is integrated. In addition to the EML, the analog optical transmitter 300 may be implemented by a combination of a laser and a Mach-Zehnder optical modulator or a direct modulation laser.

The optical signal (hereinafter, referred to as an “IFoF signal”) output from the analog optical transmitter 300 is transmitted to the reception side of the optical transmission system via the analog optical transmission line (AOTL).

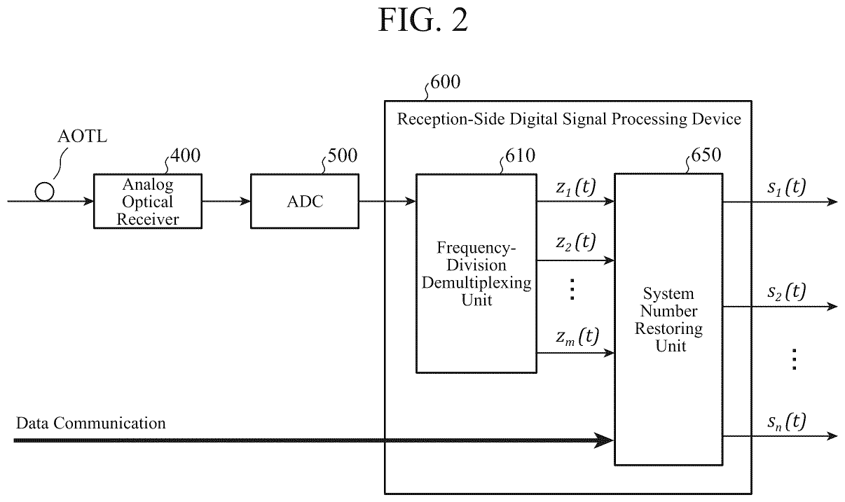

FIG. 2 is a block diagram illustrating a functional configuration on the reception side of the optical transmission system according to the first embodiment. As illustrated in FIG. 2, the optical transmission system according to the first embodiment includes, on the reception side, an analog optical receiver 400, an ADC 500, and a reception-side digital signal processing device 600. As illustrated in FIG. 2, the reception-side digital signal processing device 600 includes a frequency-division demultiplexing unit 610 and a system number restoring unit 650. The reception side of the optical transmission system may be considered as, for example, an A-RoF optical line terminal device.

### Regarding Data Transmission

As illustrated in FIGS. 1 and 2, data communication of information regarding the matrix W is performed from the transmission side to the reception side of the optical transmission system. The data communication may be implemented by a digital optical transceiver such as a small form-factor pluggable (SFP).

If the SFP related to the data communication is of a wavelength different from that of the EML related to the analog optical communication, the optical transmission line related to the frequency-division multiplexing unit 120 and the frequency-division demultiplexing unit 610 can be used for the communication of the information related to the matrix W without separately using a data communication path.

The data communication may be implemented by a digital transceiver other than the SFP. The data communication between the transmission side and the reception side for the purpose of transmitting and receiving data is not limited to optical transmission, and may be radio transmission. That is, the optical transmission system according to the present disclosure technology may use a combination of both IFoF scheme optical fiber radio transmission and radio transmission.

### Analog Optical Receiver 400

The analog optical receiver 400 is a component that converts the IFoF signal transmitted from the analog optical transmission line (AOTL) into an analog electrical signal. That is, the analog optical receiver 400 is an optical-to-electrical converter (OEC). The analog optical receiver 400 is implemented by, for example, a photo diode.

The analog optical receiver 400 corresponds to the analog optical transmitter 300 on the transmission side. The analog optical receiver 400 on the reception side acts reversely from the analog optical transmitter 300 on the transmission side.

The analog electrical signal output from the analog optical receiver 400 is transmitted to the ADC 500.

### ADC 500

The ADC 500 is a component that converts an analog signal into a digital signal. The ADC in the name of the ADC 500 is an acronym of analog-to-digital converter. The signal converted into the digital signal by the ADC 500 is transmitted to the reception-side digital signal processing device 600.

### Reception-Side Digital Signal Processing Device 600

The reception-side digital signal processing device 600 is a component that implements IF channel separation on the reception side by an approach of digital signal processing in an IFoF scheme optical transmission system. Details of the IF channel separation will be apparent in the description regarding the frequency-division demultiplexing unit 610 to be described later. In general, as a method of implementing the IF channel separation, an approach by an analog circuit is also conceivable in addition to an approach of digital signal processing. Advantages of the digital signal processing include a small-scale circuit, excellent flexibility, and excellent separation capability as compared with those by the analog circuit.

### Frequency-Division Demultiplexing Unit 610 Included in Reception-Side Digital Signal Processing Device 600

The frequency-division demultiplexing unit 610 included in the reception-side digital signal processing device 600 is a component that separates the signal obtained by multiplexing (Muxing) in the intermediate frequency (IF) into the signal channels again. The processing performed by the frequency-division demultiplexing unit 610 is sometimes referred to as demultiplexer processing, Demultiplexing, or referred to as Demuxing for short. In particular, the demultiplexer for the intermediate frequency (IF) is sometimes described as IF-DeMUX. The processing performed by the IF-DeMUX is sometimes described as IF-DeMUX processing.

### System Number Restoring Unit 650 Included in Reception-Side Digital Signal Processing Device 600

The system number restoring unit 650 included in the reception-side digital signal processing device 600 is a component that restores the system number from m to n. The system number restoring unit 650 uses the matrix W obtained by the parameter updating unit 160 in order to restore the system number from m to n. It is important that the matrix W used for the restoration by the system number restoring unit 650 is Hermitian transpose of the matrix W^{H} used for the compression by the system number compressing unit 150 on the transmission side, that is, synchronization (simultaneity) is achieved. The present disclosure technology may use a time stamp in order to synchronize the matrix W^{H} on the transmission side and the matrix W on the reception side. An example of a technique for achieving synchronization between the matrix W^{H} on the transmission side and the matrix W on the reception side is described in a third embodiment.

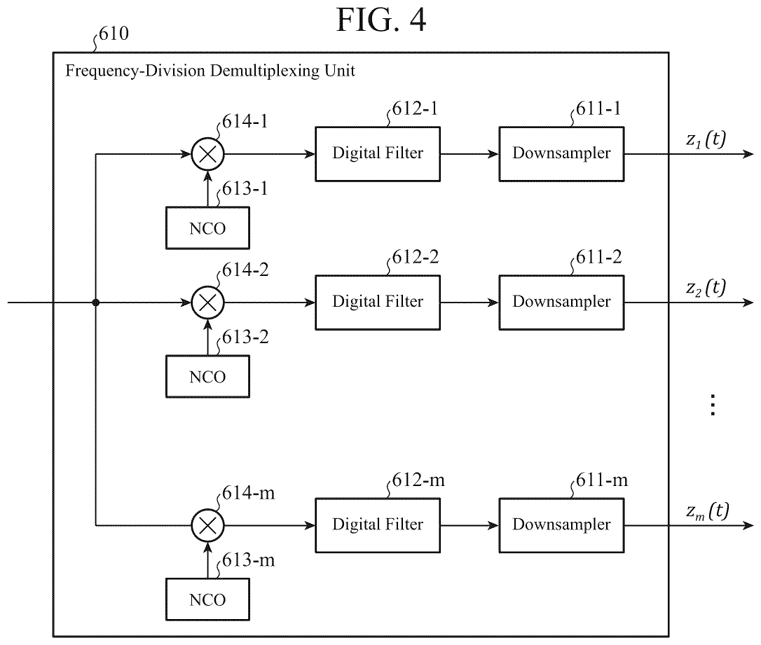

FIG. 4 is a block diagram illustrating a detailed function of the frequency-division demultiplexing unit 610 included in the reception-side digital signal processing device 600 according to the first embodiment. As illustrated in FIG. 4, the frequency-division demultiplexing unit 610 includes the digital data streams that output m signal strings (z₁(t), z₂(t), . . . , and zₘ(t)). As illustrated in FIG. 4, each digital data stream includes, for example, a downsampler 611, a digital filter 612, an NCO 613, and a multiplier 614. This configuration forms a pair with the frequency-division multiplexing unit 120 on the reception side illustrated in FIG. 3. As the frequency-division multiplexing unit 120 on the reception side, a functional block related to a first digital data stream is distinguished by adding “-1” after the reference numerals such as a downsampler 611-1, a digital filter 612-1, an NCO 613-1, and a multiplier 614-1. In the present specification, functional blocks related to other digital data streams are also distinguished by similar reference numerals.

A multiplier 614-i in an i-th digital stream multiplies the digital signal of which sampling is performed by the ADC 500 by an output from an NCO 613-i. Multiplying an NCO frequency (-fᵢ) means shifting in the frequency domain by the NCO frequency (-fᵢ), that is, frequency shifting.

The NCO 613-i in the i-th digital stream generates the NCO frequency (-fᵢ) opposite to that of the i-th NCO 123-i on the transmission side. More specifically, the NCO 613-i in the i-th digital stream generates a data string of a complex number (z in script font) given by the following expression.

$$for k = 0 , 1 , 2 , \qquad ( 8 )$$

$$\{ \begin{matrix}transmission - side NCO & {𝓏}_{TX \_ k} = {e}^{j ω kT} \\ reception - side NCO & {𝓏}_{RX \_ k} = {e}^{- j ω kT}\end{matrix}$$

Note that, an angular frequency ω appearing in Expression (8) is equal to 2πfᵢ. In addition, T appearing in Expression (8) represents a sampling period.

The digital filter 612 in the digital data stream may be a band-pass filter that extracts a signal in a necessary frequency band.

The downsampler 611 in the digital data stream performs sampling depending on an output rate. Specifically, the downsampler 611 performs, for example, thinning processing, decreases a sampling rate, and implements the sampling depending on the output rate.

The signal strings (z₁(t), z₂(t), . . . , and zₘ(t)) obtained by the downsampler 611 may be of zero (0) [Hz] baseband or may have another intermediate frequency (IF). The intermediate frequency (IF) of the signal output by the frequency-division demultiplexing unit 610 is a frequency corresponding to that of the frequency-division multiplexing unit 120 on the transmission side.

In FIG. 4, a configuration in which the m signal strings (z₁(t), z₂(t), . . . , and zₘ(t)) are output by parallel processing is illustrated, but the present disclosure technology is not limited thereto. The frequency-division demultiplexing unit 610 may perform the signal processing not in parallel (parallel) but in series (series), that is, in multiple stages.

In general, as a method of compressing the number of signal channels of a transmission system to m (m<n) when the original signal string x(t) is n-dimensional, a method of mechanically reducing the bit number in quantization of the original signal string x(t) is also conceivable. However, this method always lowers the bit number of the original signal string x(t) regardless of a property of the original signal string x(t), and thus is neither adaptive nor intelligent.

As described above, since the optical transmission system according to the first embodiment has the above-described configuration, there is an action that the number of signal channels of the transmission system is adaptively (adaptively) compressed to m (m<n) when the original signal string x(t) is n-dimensional. With this action, the optical transmission system according to the first embodiment can effectively use a finite number (m) of signal channels included in the transmission system.

### Second Embodiment

An optical transmission system according to a second embodiment is a variation of the optical transmission system according to the present disclosure technology. Unless otherwise specified, the same reference numerals as those used in the first embodiment are used in the second embodiment. In the second embodiment, the description overlapping with that of the first embodiment is appropriately omitted.

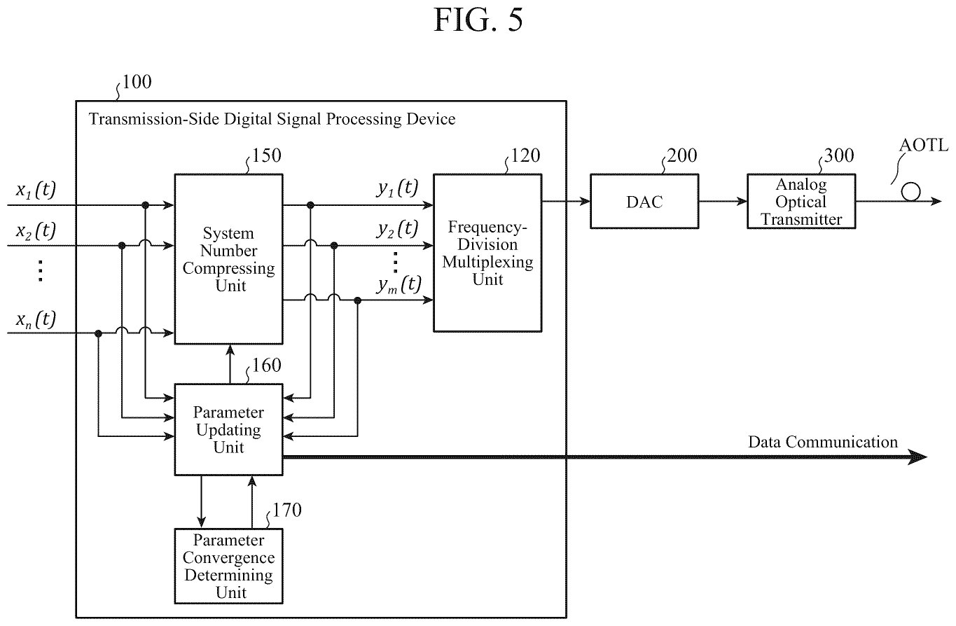

FIG. 5 is a block diagram illustrating a functional configuration on a transmission side of the optical transmission system according to the second embodiment. As illustrated in FIG. 5, the optical transmission system according to the second embodiment includes a parameter convergence determining unit 170 in addition to the configuration described in the first embodiment in a transmission-side digital signal processing device 100 on a transmission side.

### Parameter Convergence Determining Unit 170 Included in Transmission-Side Digital Signal Processing Device 100

The parameter convergence determining unit 170 included in the transmission-side digital signal processing device 100 is a component that determines whether a matrix W to be updated converges in update processing of the matrix W as a parameter. The parameter convergence determining unit 170 calculates a value of the following evaluation function (Vₖ) for each update, for example, using the error vector (eₖ) appearing in Expression (6).

$${V}_{k} := {{\vec{e}}_{k}^{T}}^{} {\vec{e}}_{k} = {( {\vec{x}}_{k} − {W}_{k} {\vec{y}}_{k} )}^{T} ( {\vec{x}}_{k} − {W}_{k} {\vec{y}}_{k} ) \qquad ( 9 )$$

Here, superscript T appearing in Expression (9) represents transpose. The evaluation function (Vₖ) is a scalar function. The evaluation function (Vₖ) given by Expression (9) is essentially the same as the evaluation function (V) given by Expression (2) appearing in the first embodiment.

The parameter convergence determining unit 170 calculates a difference between the evaluation function (Vₖ₋₁) of previous time (sampling is k−1) and the evaluation function (Vₖ) of this time (sampling is k) and compares the difference with a threshold (ε). The parameter convergence determining unit 170 determines that the matrix W to be updated converges when an absolute value of the difference between the evaluation function (Vₖ₋₁) of the previous time (sampling is k−1) and the evaluation function (Vₖ) of this time (sampling is k) is sufficiently small (smaller than the threshold (ε)) as expressed in the following expression.

$$\{ \begin{matrix}if \vert {V}_{k - 1} - {V}_{k} \vert < ε & … determined to be converged yet \\ else & … determined not to be converged yet\end{matrix} \qquad ( 10 )$$

The information obtained by the parameter convergence determining unit 170, specifically, the evaluation function (Vₖ) and the difference value (Vₖ₋₁−Vₖ) of the evaluation function appearing in Expression (10) can be used in various ways.

The simplest way is to use the evaluation function (Vₖ) as an evaluation index of the optical transmission system. The optical transmission system according to the present disclosure technology may display the value of the evaluation function (Vₖ) as a graph or the like on a display on the reception side, for example. Since the evaluation function (Vₖ) indicates the error vector (eₖ) in a quadratic form as expressed in Expression (9), the value of the evaluation function (Vₖ) is an index indicating how much information is lost in the system number compressing unit 150. If the value of the evaluation function (Vₖ) is zero (0), it can be said that the error vector (eₖ) is a zero vector (0 vector), and there is no information lost in the system number compressing unit 150 for the sampling time.

It is possible that the parameter updating unit 160 performs data communication of the information of the matrix W to the reception side only when the parameter convergence determining unit 170 determines that the update of the matrix W has converged. The reason for restricting the transmission of the information of the matrix W to the reception side in this manner is based on an estimation principle that a quality of data restoration in the system number restoring unit 650 on the optical transmission system reception side cannot be ensured even when the matrix W when the update does not sufficiently converge is used.

In the update of the matrix W performed by the parameter updating unit 160, the value does not necessarily converge within a certain number of times. The parameter convergence determining unit 170 may count the number of times of updating the matrix W in the parameter updating unit 160 and perform the data communication of the information of the matrix W to the reception side when the number of times of updating reaches a predetermined constant number (Uₘₐₓ) even when a convergence condition represented in an upper part of Expression (10) is not satisfied.

The threshold (ε) and an upper limit value (Uₘₐₓ) of the number of times of updating in Expression (10) may be parameter values that can be appropriately set by a user depending on use of the optical transmission system. These parameter values may be stored in a memory or the like included in the optical transmission system so that the optical transmission system can access and use the memory.

In the optical transmission system according to the second embodiment, it is possible that the parameter convergence determining unit 170 does not stop updating the parameter in the parameter updating unit 160 even after the convergence condition represented in the upper part of Expression (10) is satisfied. By continuing updating the parameter in the parameter updating unit 160 even after the convergence condition is satisfied, the optical transmission system according to the second embodiment can continue to act adaptively.

As described above, in the optical transmission system according to the second embodiment, the parameter convergence determining unit 170 focuses on an absolute value of the difference between the evaluation function (Vₖ₋₁) of the previous time (sampling is k−1) and the evaluation function (Vₖ) of this time (sampling is k), but the present disclosure technology is not limited thereto. The optical transmission system according to the present disclosure technology may determine whether the parameter has converged by focusing on the value itself of the evaluation function (Vₖ). The optical transmission system according to the present disclosure technology may determine whether the parameter has converged by focusing on the updating matrix (P), the error vector (eₖ), or an intermediate generation vector of updating (gₖ, hₖ). Furthermore, the optical transmission system according to the present disclosure technology may prepare two or more thresholds and determine whether the parameter has converged using an algorithm used in a chattering canceller.

In a special case where real-time communication is not required, the optical transmission system according to the second embodiment may be used in such a manner that the parameter convergence determining unit 170 stocks communication data and does not flow the communication data to the analog optical transmission line (AOTL) until the convergence condition represented in the upper part of Expression (10) is satisfied.

As described above, since the optical transmission system according to the second embodiment has the above-described configuration, in addition to the effect described in the first embodiment, the effect of maintaining the quality of data restoration in the system number restoring unit 650 on the optical transmission system reception side is obtained because the matrix W of which update is determined to have converged is used.

### Third Embodiment

An optical transmission system according to a third embodiment is a variation of the optical transmission system according to the present disclosure technology. Unless otherwise specified, the same reference numerals as those used in the already described embodiment are used in the third embodiment. In the third embodiment, the description overlapping with that of the already described embodiment is appropriately omitted.

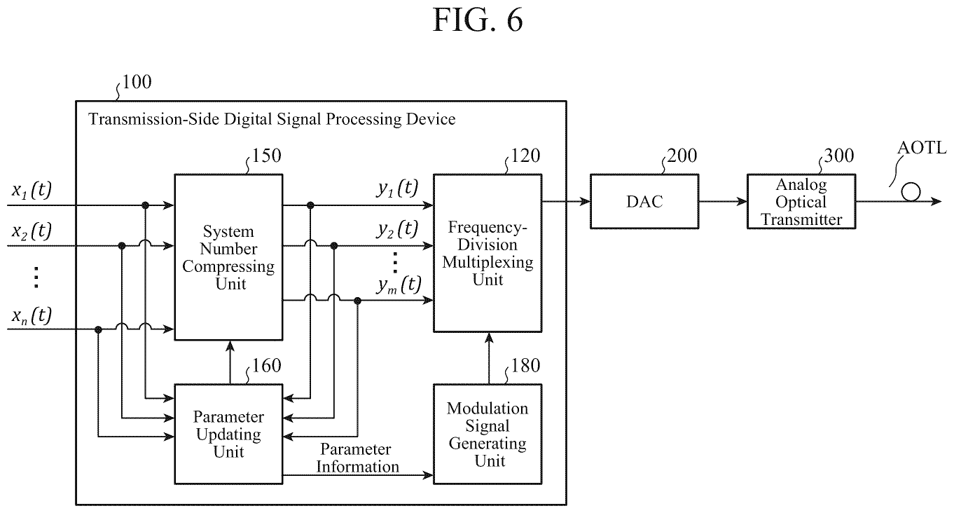

FIG. 6 is a block diagram illustrating a functional configuration on a transmission side of the optical transmission system according to the third embodiment. As illustrated in FIG. 6, the optical transmission system according to the third embodiment includes a modulation signal generating unit 180 in addition to the configuration described in the first embodiment (refer to FIG. 1) in a transmission-side digital signal processing device 100.

FIG. 6 does not illustrate a data communication transmission system.

### Modulation Signal Generating Unit 180 Included in Transmission-Side Digital Signal Processing Device 100

The modulation signal generating unit 180 included in the transmission-side digital signal processing device 100 is a component that converts parameter information transmitted from a parameter updating unit 160 into a modulation signal so that the parameter information can be transmitted to an analog optical transmission line (AOTL) similarly to y₁(t), y₂(t), . . . , and yₘ(t).

The conversion performed by the modulation signal generating unit 180 may be phase-shift keying (PSK) such as quadrature phase-shift keying, quaternary phase-shift keying, or quadriphase phase-shift keying (QPSK).

The signal generated by the modulation signal generating unit 180 may be a multi subcarrier signal such as orthogonal frequency-division multiplexing (OFDM).

An intermediate frequency (IF) different from that of y₁(t), y₂(t), . . . , and yₘ(t) is allocated to the signal generated by the modulation signal generating unit 180. The signal generated by the modulation signal generating unit 180 is transmitted to a frequency-division multiplexing unit 120. In the example illustrated in FIG. 6, m+1 signal strings are multiplexed in the frequency-division multiplexing unit 120 in the transmission-side digital signal processing device 100.

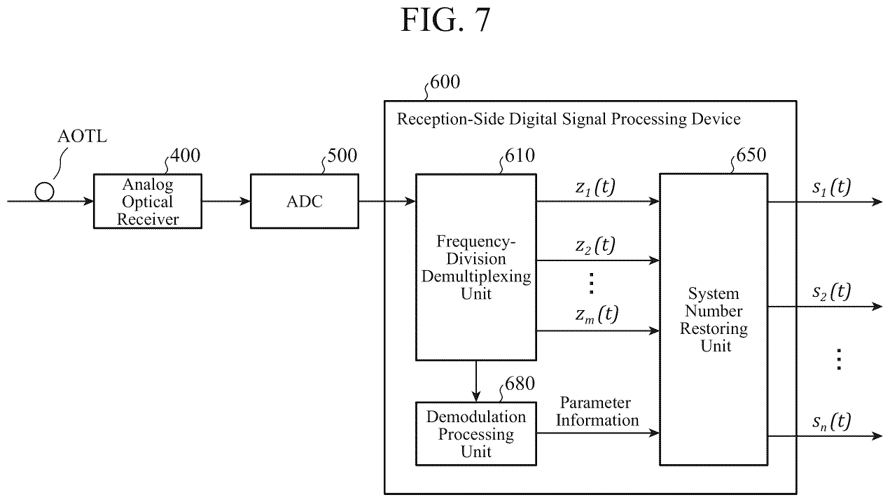

FIG. 7 is a block diagram illustrating a functional configuration on a reception side of the optical transmission system according to the third embodiment. As illustrated in FIG. 7, the optical transmission system according to the third embodiment includes a demodulation processing unit 680 in addition to the configuration described in the first embodiment (refer to FIG. 2) in a reception-side digital signal processing device 600. The demodulation processing unit 680 is a component corresponding to the modulation signal generating unit 180 in the transmission-side digital signal processing device 100.

Similarly to FIG. 6, FIG. 7 does not illustrate a data communication transmission system.

In the example illustrated in FIG. 7, corresponding to FIG. 6, a signal transmitted from an ADC 500 is demultiplexed into m+1 signal strings in a frequency-division demultiplexing unit 610 in the reception-side digital signal processing device 600. Out of the m+1 signal strings generated by demultiplexing, m signal strings (z₁(t), z₂(t), . . . , and zₘ(t)) corresponding to y₁(t), y₂(t), . . . , and yₘ(t) are transmitted to a system number restoring unit 650. Out of the m+1 signal strings generated by demultiplexing, those corresponding to the signal generated by the modulation signal generating unit 180 are transmitted to the demodulation processing unit 680.

### Demodulation Processing Unit 680 Included in Reception-Side Digital Signal Processing Device 600

The demodulation processing unit 680 included in the reception-side digital signal processing device 600 is a component that performs demodulation processing on the parameter information converted into the modulation signal by the modulation signal generating unit 180 included in the transmission-side digital signal processing device 100. In a case where the parameter information converted into the modulation signal by the modulation signal generating unit 180 included in the transmission-side digital signal processing device 100 is a matrix W, the demodulation processing unit 680 included in the reception-side digital signal processing device 600 demodulates the modulation signal and extracts the matrix W. In this manner, the modulation signal generating unit 180 and the demodulation processing unit 680 form a pair.

As described above, since the optical transmission system according to the third embodiment has the above-described configuration, the parameter information can be transmitted to the reception side without using the data communication transmission system, and the effect similar to that described in the first embodiment is obtained.

### Fourth Embodiment

An optical transmission system according to a fourth embodiment is a variation of the optical transmission system according to the present disclosure technology. Unless otherwise specified, the same reference numerals as those used in the already described embodiment are used in the fourth embodiment. In the fourth embodiment, the description overlapping with that of the already described embodiment is appropriately omitted.

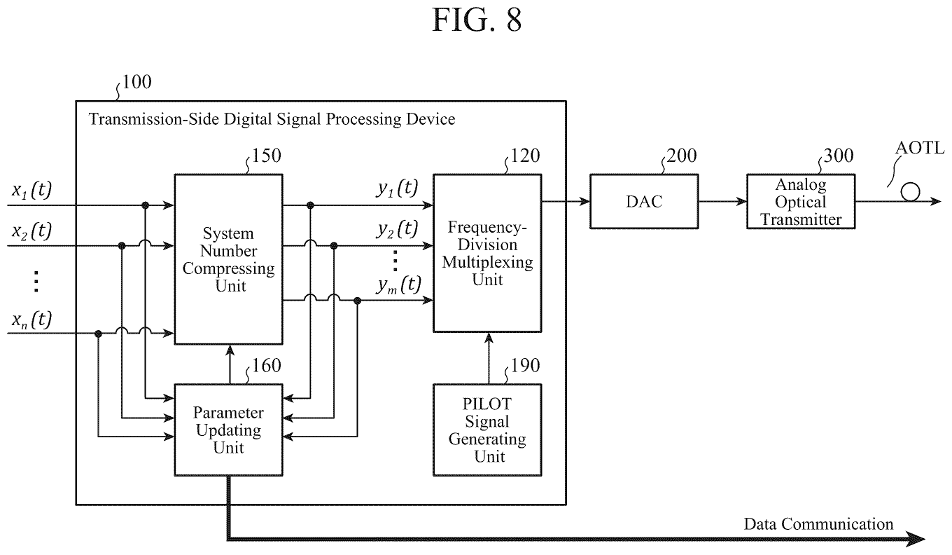

FIG. 8 is a block diagram illustrating a functional configuration on a transmission side of the optical transmission system according to the fourth embodiment. As illustrated in FIG. 8, the optical transmission system according to the fourth embodiment includes a PILOT signal generating unit 190 in addition to the configuration described in the first embodiment (refer to FIG. 1) in a transmission-side digital signal processing device 100.

### PILOT Signal Generating Unit 190 Included in Transmission-Side Digital Signal Processing Device 100

The PILOT signal generating unit 190 included in the transmission-side digital signal processing device 100 is a component that generates a PILOT signal that is a source for calculating a phase correction value of phase correction performed in a reception-side digital signal processing device 600 to be described later.

Details of the phase correction performed by the reception-side digital signal processing device 600 will be apparent from the following description.

The PILOT signal generated by the PILOT signal generating unit 190 is transmitted to a frequency-division multiplexing unit 120.

The PILOT signal generated by the PILOT signal generating unit 190 is, for example, a sin wave of two different frequencies (hereinafter, referred to as a “two-tone sin wave”). Two different frequencies (fₐ and f_{b}) in the two-tone sin wave different from an intermediate frequency (IF) used for y₁(t), y₂(t), . . . , and yₘ(t) are selected. A difference (f_{b}−fₐ) between the two different frequencies (fₐ and f_{b}) is described as Δf in the present specification. In the present specification, fₐ is smaller than f_{b}, and Δf is a positive value. The two-tone sin wave is generated so as to be output in a pulse form, for example, and in such a manner that phases are both zero (0) [rad] at a time of output moment. In any case, both the phase of the wave at frequency fₐ and at frequency f_{b} of the two-tone sin wave is assumed to be known when applying DFT (Digital Fourier Transformation). For example, the DFT may be based on the time of output moment, and sampling may be started from the output moment. For ease of description, in the present specification, it is assumed that, when the above-describe DFT is performed on the PILOT signal, a phase delay of the sin wave of the frequency f_{b} as seen from the sin wave of the frequency fₐ is zero (0) [rad].

The intermediate frequencies (IFs) used for y₁(t), y₂(t), . . . , and yₘ(t) are assumed to be f₁, f₂, . . . , and fₘ in the present specification. For convenience, in the present specification, a magnitude relationship among f₁, f₂, . . . , and fₘ, and between fₐ and f_{b} is as expressed by the following expression.

$${f}_{1} < {f}_{2} < … < {f}_{m} \qquad ( 11 )$$

$$and$$

$${f}_{m} < {\underbrace{{f}_{a} < {f}_{b}}}_{{f}_{b} - {f}_{a} = Δ f}$$

The frequency-division multiplexing unit 120 according to the fourth embodiment multiplexes m signal strings (y₁(t), y₂(t), . . . , and yₘ(t)) and the two-tone sin wave. The signal multiplexed in the frequency-division multiplexing unit 120 is transmitted to an analog optical transmission line (AOTL) via a DAC 200 and an analog optical transmitter 300.

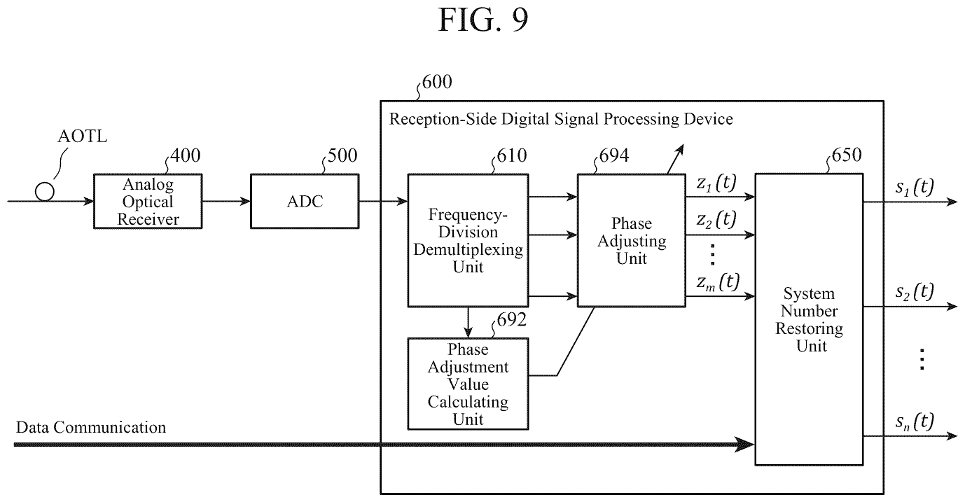

FIG. 9 is a block diagram illustrating a functional configuration on a reception side of the optical transmission system according to the fourth embodiment. As illustrated in FIG. 9, the optical transmission system according to the fourth embodiment includes a phase adjustment value calculating unit 692 and a phase adjusting unit 694 in addition to the configuration described in the first embodiment (refer to FIG. 2) in the reception-side digital signal processing device 600.

In the example illustrated in FIG. 9, corresponding to FIG. 8, a signal transmitted from an ADC 500 is demultiplexed into m+2 signal strings in a frequency-division demultiplexing unit 610 in the reception-side digital signal processing device 600. Out of the m+2 signal strings generated by demultiplexing, m signal strings (z₁(t), z₂(t), . . . , and zₘ(t)) corresponding to y₁(t), y₂(t), . . . , and yₘ(t) are transmitted to the phase adjusting unit 694. Out of the m+2 signal strings generated by demultiplexing, those corresponding to the two-tone sin wave are transmitted to the phase adjustment value calculating unit 692.

### Phase Adjustment Value Calculating Unit 692 Included in Reception-Side Digital Signal Processing Device 600

The phase adjustment value calculating unit 692 included in the reception-side digital signal processing device 600 is a component that calculates a phase adjustment value used in phase adjustment of the m signal strings (z₁(t), z₂(t), . . . , and zₘ(t)) generated in the frequency-division demultiplexing unit 610.

The phase adjustment value calculating unit 692 performs DFT processing on the two-tone sin wave demultiplexed and transmitted. For example, the DFT performed by the phase adjustment value calculating unit 692 may be based on the time of the moment at which the two-tone sin wave is received, and sampling may be started from the moment of reception.

In the present specification, it is assumed that, when the phase adjustment value calculating unit 692 performs the above-describe DFT, a phase delay of the sin wave of the frequency f_{b} as seen from the sin wave of the frequency fₐ is Δθ [rad]. The phase adjustment value calculated by the phase adjustment value calculating unit 692 is Δθ [rad] related to this phase delay. The optical transmission system according to the fourth embodiment attempts phase adjustment based on the premise that, when a frequency difference between certain two signals is Δf, a new phase difference is generated by Δθ [rad] by passing through the analog optical transmission line (AOTL). Note that, strictly speaking, actually, the phase difference (Δθ) is not determined only by a relative frequency difference (Δf), and the phase difference (Δθ) also differs depending on a value of an absolute intermediate frequency (IF).

The phase adjustment value calculated by the phase adjustment value calculating unit 692, that is, Δθ [rad] is transmitted to the phase adjusting unit 694.

### Phase Adjusting Unit 694 Included in Reception-Side Digital Signal Processing Device 600

The phase adjusting unit 694 included in the reception-side digital signal processing device 600 is a component that performs phase adjustment of the m signal strings (z₁(t), z₂(t), . . . , and zₘ(t)) generated in the frequency-division demultiplexing unit 610 using the phase adjustment value calculated by the phase adjustment value calculating unit 692.

Specifically, the phase adjusting unit 694 calculates a complex number (αᵢ, i=1, 2, . . . , and m) given by the following expression for each of the m signal strings (z₁(t), z₂(t), . . . , and zₘ(t)) to multiply.

$$for i = 1 , 2 , … , m \qquad ( 12 )$$

$${a}_{i} = exp ( - {ja}_{i} Δ θ )$$

$$wherein$$

$${a}_{i} = \frac{{f}_{i} - {f}_{1}}{Δ f}$$

Here, aᵢ given in a lower part of Expression (12) is referred to as a “correction factor” in the present specification. The correction factor (aᵢ) and Expression (12) are obtained by embodying the premise that when a frequency difference between two certain signals is Δf, a new phase difference is generated by Δθ [rad] by passing through the analog optical transmission line (AOTL), and performing linear interpolation to expand.

In the optical transmission system according to the fourth embodiment, the phase adjusting unit 694 calculates the complex number (αᵢ, i=1, 2, . . . , and m) given by Expression (12) for each of the m signal strings (z₁(t), z₂(t), . . . , and zₘ(t)) to multiply, whereby the phase difference in each of the m signal strings (z₁(t), z₂(t), . . . , and zₘ(t)) is expected to approach the phase difference in each of the m signal strings (y₁(t), y₂(t), . . . , and yₘ(t)) in the transmission-side digital signal processing device 100.

The multiplication of the complex number (αᵢ, i=1, 2, . . . , and m) given in Expression (12) is, strictly speaking, performed on the frequency domain. Therefore, more precisely, the phase adjusting unit 694 converts the signal string transmitted from the frequency-division demultiplexing unit 610 into a frequency domain, multiplies the signal string by the complex number (αᵢ, i=1, 2, . . . , and m) given by Expression (12), and converts the signal string into a time domain again. Details will be apparent from the description in a sixth embodiment.

The m signal strings (z₁(t), z₂(t), . . . , and zₘ(t)) of which phases are adjusted by the phase adjusting unit 694 are transmitted to a system number restoring unit 650.

As described above, even when the space defined by x(t) when the time t is changed is of a dimension higher than the m-dimension, the matrix W^{H} performs mapping to the m-dimensional partial space while reducing the dimension with less influence in such a manner that the difference between the original signal string x(t) and the compressed and restored signal string WW^{H}x(t) does not become large. Here, the signals mapped to the m-dimensional partial space are y₁(t), y₂(t), . . . , and yₘ(t).

As described above, the optical transmission system according to the fourth embodiment can bring the phase difference in each of the m signal strings (z₁(t), z₂(t), . . . , and zₘ(t)) closer to the phase difference in each of the m signal strings (y₁(t), y₂(t), . . . , and yₘ(t)) in the transmission-side digital signal processing device 100 by an action of the phase adjusting unit 694. This action brings a trajectory of z₁(t), z₂(t), . . . , and zₘ(t) in the m-dimensional partial space closer to the trajectory of y₁(t), y₂(t), . . . , and yₘ(t) in the m-dimensional partial space. That is, this action improves restoration accuracy in system number restoration processing by multiplication operation of the matrix W in the system number restoring unit 650.

As described above, since the optical transmission system according to the fourth embodiment has the above-described configuration, in addition to the effect described in the first embodiment, the effect of improving the restoration accuracy in the system number restoration processing by the multiplication operation of the matrix W in the system number restoring unit 650 is obtained.

### Fifth Embodiment

An optical transmission system according to a fifth embodiment is a variation of the optical transmission system according to the present disclosure technology. Specifically, the optical transmission system according to the fifth embodiment indicates that the present disclosure technology can also be implemented by software.

Unless otherwise specified, the same reference numerals as those used in the already described embodiment are used in the fifth embodiment. In the fifth embodiment, the description overlapping with that of the already described embodiment is appropriately omitted.

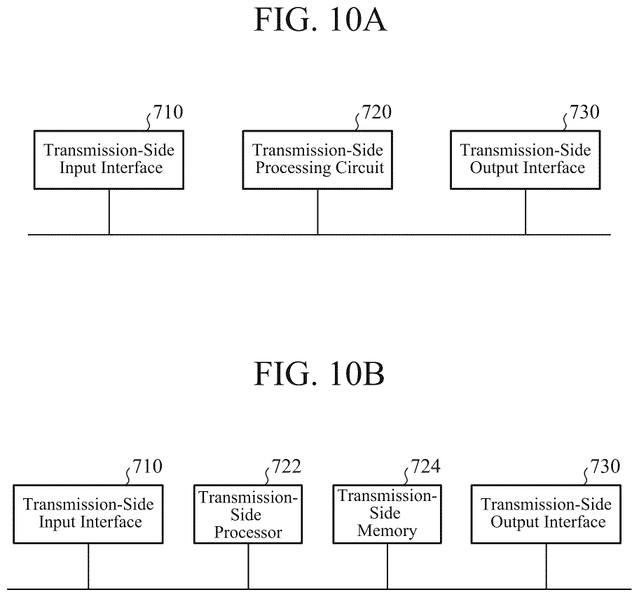

FIG. 10 is a hardware configuration diagram of a transmission-side digital signal processing device 100 according to the fifth embodiment. FIG. 10A in an upper part of FIG. 10 illustrates a case where a function of the optical transmission system (transmission side) according to the present disclosure technology is implemented by hardware. FIG. 10B in a lower part of FIG. 10 illustrates a case where a function of the optical transmission system (transmission side) according to the present disclosure technology is implemented by software.

In the configuration illustrated in FIG. 10A, the transmission-side digital signal processing device 100 includes a transmission-side input interface 710, a transmission-side processing circuit 720, and a transmission-side output interface 730.

In the configuration illustrated in FIG. 10B, the transmission-side digital signal processing device 100 includes a transmission-side input interface 710, a transmission-side processor 722, a transmission-side memory 724, and a transmission-side output interface 730.

Functions of a frequency-division multiplexing unit 120, a system number compressing unit 150, a parameter updating unit 160, a parameter convergence determining unit 170, a modulation signal generating unit 180, and a PILOT signal generating unit 190 in the transmission-side digital signal processing device 100 are implemented by a processing circuit. The processing circuit may be either dedicated hardware (refer to FIG. 10A) or a central processing unit (CPU; also referred to as a central processing device, a processing device, an arithmetic device, a microprocessor, a microcomputer, a processor, or a DSP) that executes a program stored in a memory (refer to FIG. 10B).

As illustrated in FIG. 10A, in a case where the processing circuit is the dedicated hardware, that is, implemented by the transmission-side processing circuit 720, the transmission-side processing circuit 720 may be a single circuit, a composite circuit, a programmed processor, a parallel-programmed processor, ASIC, FPGA, or a combination thereof. The functions of the frequency-division multiplexing unit 120, the system number compressing unit 150, the parameter updating unit 160, the parameter convergence determining unit 170, the modulation signal generating unit 180, and the PILOT signal generating unit 190 may be implemented by a plurality of independent transmission-side processing circuits 720, or collectively implemented by one transmission-side processing circuit 720.

As illustrated in FIG. 10B, in a case where the processing circuit is the CPU, more specifically, in a case where the processing circuit is the transmission-side processor 722, the functions of the frequency-division multiplexing unit 120, the system number compressing unit 150, the parameter updating unit 160, the parameter convergence determining unit 170, the modulation signal generating unit 180, and the PILOT signal generating unit 190 may be implemented by software, firmware, or a combination of software and firmware. The software and firmware are described as a program and stored in the transmission-side memory 724. The transmission-side processor 722 implements the functions of the respective units by reading and executing the program stored in the transmission-side memory 724. That is, the transmission-side digital signal processing device 100 includes the transmission-side memory 724 for storing a program that, when executed by the transmission-side processor 722, results in execution of processing contents executed by the frequency-division multiplexing unit 120, the system number compressing unit 150, the parameter updating unit 160, the parameter convergence determining unit 170, the modulation signal generating unit 180, and the PILOT signal generating unit 190 described in the embodiments. It can also be said that these programs cause a computer to execute the procedures and methods performed in the frequency-division multiplexing unit 120, the system number compressing unit 150, the parameter updating unit 160, the parameter convergence determining unit 170, the modulation signal generating unit 180, and the PILOT signal generating unit 190. Here, the transmission-side memory 724 may be a nonvolatile or volatile semiconductor memory such as RAM, ROM, a flash memory, EPROM, or EEPROM. The transmission-side memory 724 may include a disk such as a magnetic disk, a flexible disk, an optical disk, a compact disk, a mini disk, or a DVD. Furthermore, the transmission-side memory 724 may be an HDD or an SSD.

The transmission-side memory 724 may store the parameter updated by the parameter updating unit 160, particularly, the parameter determined to have converged by the parameter convergence determining unit 170. The transmission-side memory 724 may store information necessary for the PILOT signal generating unit 190 to generate the PILOT signal.

The transmission-side output interface 730 may include the function of the DAC 200 or the functions of the DAC 200 and the analog optical transmitter 300.

Some of the functions of the frequency-division multiplexing unit 120, the system number compressing unit 150, the parameter updating unit 160, the parameter convergence determining unit 170, the modulation signal generating unit 180, and the PILOT signal generating unit 190 may be implemented by dedicated hardware, and some of the other functions may be implemented by software or firmware. In this manner, the processing circuit can implement the functions of the frequency-division multiplexing unit 120, the system number compressing unit 150, the parameter updating unit 160, the parameter convergence determining unit 170, the modulation signal generating unit 180, and the PILOT signal generating unit 190 by hardware, software, firmware, or a combination thereof.

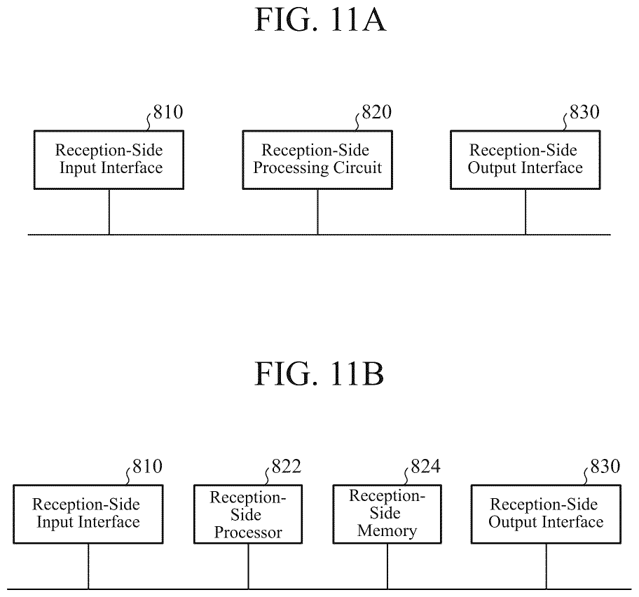

FIG. 11 is a hardware configuration diagram of a reception-side digital signal processing device 600 according to the fifth embodiment. FIG. 11A in an upper part of FIG. 11 illustrates a case where a function of the optical transmission system (reception side) according to the present disclosure technology is implemented by hardware. FIG. 11B in a lower part of FIG. 11 illustrates a case where a function of the optical transmission system (reception side) according to the present disclosure technology is implemented by software.

In the configuration illustrated in FIG. 11A, the reception-side digital signal processing device 600 includes a reception-side input interface 810, a reception-side processing circuit 820, and a reception-side output interface 830.

In the configuration illustrated in FIG. 11B, the reception-side digital signal processing device 600 includes a reception-side input interface 810, a reception-side processor 822, a reception-side memory 824, and a reception-side output interface 830.

Functions of the frequency-division demultiplexing unit 610, the system number restoring unit 650, the demodulation processing unit 680, the phase adjustment value calculating unit 692, and the phase adjusting unit 694 in the reception-side digital signal processing device 600 are implemented by the processing circuit. The processing circuit may be either dedicated hardware (refer to FIG. 11A) or a CPU that executes a program stored in a memory (refer to FIG. 11B).

As illustrated in FIG. 11A, in a case where the processing circuit is the dedicated hardware, that is, implemented by the reception-side processing circuit 820, the reception-side processing circuit 820 may be a single circuit, a composite circuit, a programmed processor, a parallel-programmed processor, ASIC, FPGA, or a combination thereof. The functions of the frequency-division demultiplexing unit 610, the system number restoring unit 650, the demodulation processing unit 680, the phase adjustment value calculating unit 692, and the phase adjusting unit 694 may be implemented by a plurality of independent reception-side processing circuits 820, or collectively implemented by one reception-side processing circuit 820.

As illustrated in FIG. 11B, in a case where the processing circuit is the CPU, more specifically, in a case where the processing circuit is the reception-side processor 822, the functions of the frequency-division demultiplexing unit 610, the system number restoring unit 650, the demodulation processing unit 680, the phase adjustment value calculating unit 692, and the phase adjusting unit 694 may be implemented by software, firmware, or a combination of software and firmware. The software and firmware are described as a program and stored in the reception-side memory 824. The reception-side processor 822 implements the functions of the respective units by reading and executing the program stored in the reception-side memory 824. That is, the reception-side digital signal processing device 600 includes the reception-side memory 824 for storing a program that, when executed by the reception-side processor 822, results in execution of processing contents executed by the frequency-division demultiplexing unit 610, the system number restoring unit 650, the demodulation processing unit 680, the phase adjustment value calculating unit 692, and the phase adjusting unit 694 described in the embodiments. It can also be said that these programs cause a computer to execute the procedures and methods performed in the frequency-division demultiplexing unit 610, the system number restoring unit 650, the demodulation processing unit 680, the phase adjustment value calculating unit 692, and the phase adjusting unit 694. Here, the reception-side memory 824 may be a nonvolatile or volatile semiconductor memory such as RAM, ROM, a flash memory, EPROM, or EEPROM. The reception-side memory 824 may include a disk such as a magnetic disk, a flexible disk, an optical disk, a compact disk, a mini disk, or a DVD. Furthermore, the reception-side memory 824 may be an HDD or an SSD.

The reception-side memory 824 may store the phase adjustment value (Δθ related to the phase delay) calculated by the phase adjustment value calculating unit 692 as a history together with information such as calculated date and time.

The reception-side input interface 810 may include the function of the ADC 500 or the functions of the ADC 500 and the analog optical receiver 400.

Some of the functions of the frequency-division demultiplexing unit 610, the system number restoring unit 650, the demodulation processing unit 680, the phase adjustment value calculating unit 692, and the phase adjusting unit 694 may be implemented by dedicated hardware, and some of the other functions may be implemented by software or firmware. In this manner, the processing circuit can implement the frequency-division demultiplexing unit 610, the system number restoring unit 650, the demodulation processing unit 680, the phase adjustment value calculating unit 692, and the phase adjusting unit 694 by hardware, software, firmware, or a combination thereof.

As described above, since the optical transmission system according to the fifth embodiment has the above-described configuration, this may be implemented by hardware, software, firmware or a combination thereof, and there is an action that the number of signal channels of the transmission system is adaptively (adaptively) compressed to m (m<n) when the original signal string x(t) is n-dimensional. With this action, the optical transmission system according to the fifth embodiment can effectively use a finite number (m) of signal channels included in the transmission system as the optical transmission system according to the already described embodiment.

### Sixth Embodiment

An optical transmission system according to the sixth embodiment is a variation of the optical transmission system according to the present disclosure technology. Specifically, the optical transmission system according to the sixth embodiment is a variation of the optical transmission system according to the fourth embodiment.

Unless otherwise specified, the same reference numerals as those used in the already described embodiment are used in the sixth embodiment. In the sixth embodiment, the description overlapping with that of the already described embodiment is appropriately omitted.

As illustrated in FIG. 9, the optical transmission system according to the fourth embodiment includes the phase adjustment value calculating unit 692 and the phase adjusting unit 694 in the reception-side digital signal processing device 600. Here, considering what a phase is, the phase is a periodic motion represented by a vibration or a wave motion, and is an amount indicating a progressing stage within one period. In general, a phase (θ(t)) in a certain periodic motion is given by the following expression.

$$θ ( t ) = θ ( 0 ) + ( ω t ) \qquad ( 13 )$$

Note that, ω represents an angular frequency and t represents a time. In addition, θ(0) represents an initial value at time 0.

In this manner, it can be said that the phase is a value that is obtained when the periodic motion is a target and only after the initial value (θ(0)), the angular frequency (ω), or the frequency (f=ω/(2π)), and the time (t) are given.

In the Laplace transform that implements the conversion from the time domain to the frequency domain, the time shift in the time domain is given by the following expression in the frequency domain.

$$\begin{matrix}when & ℒ [ x ( t ) ] & = & X ( s ) \\ then & ℒ [ x ( t - τ ) ] & = & {e}^{- τ s} X ( s )\end{matrix} \qquad ( 14 )$$

Here, L in script font appearing on the left side of Expression (14) means that the Laplace transform is performed on the inside of square brackets. In Expression (14), s represents a Laplace operator. In addition, x(t) is any function (time signal or the like) in the time domain.

By substituting jω into the Laplace operator s, it is possible to grasp the behavior in the angular frequency domain. When s=jω, the Laplace transform is equivalent to the Fourier transform. When s=jω, e^{-τs} on the right side of a lower part of Expression (14) has the same structure as the complex number (αᵢ, i=1, 2, . . . , and m) given by Expression (12), and is a complex number on a unit circle.

As indicated by a comparison between Expressions (12) and (14), the intention of the optical transmission system according to the fourth embodiment is to eventually correct a variation in the time delay caused by the difference in the intermediate frequency (IF).

In view of the above, it is understood that the PILOT signal generating unit 190 in the transmission-side digital signal processing device 100 is only required to simultaneously generate the multi-tone sin wave for the intermediate frequencies (f₁, f₂, . . . , and fₘ) to be used as the PILOT signal. The reception-side digital signal processing device 600 is only required to check at what timing the sin waves of the respective intermediate frequencies (f₁, f₂, . . . , and fₘ) forming the multi-tone sin wave have arrived. Then, the phase adjusting unit 694 of the reception-side digital signal processing device 600 may perform the following temporal transition correction in the time domain.

$$[ \begin{matrix}{z}_{1} ( t ) \\ {z}_{2} ( t ) \\ ⋮ \\ {z}_{m} ( t )\end{matrix} ] ⇒ [ \begin{matrix}{z}_{1} ( t + {τ}_{1} ) \\ {z}_{2} ( t + {τ}_{2} ) \\ ⋮ \\ {z}_{m} ( t + {τ}_{m} )\end{matrix} ] \qquad ( 15 )$$

Note that, τ₁, τ₂, . . . , and τₘ appearing on the right side of Expression (15) are temporal transition correction amounts in the respective signal channels. Since the temporal transition correction amount is an amount determined from a relative relationship of the signal channels, the temporal transition correction amounts (τ₂, τ₃, . . . , and τₘ) of the remaining signal channels may be determined with the first signal channel as a reference, that is, with τ₁=0.

It may be said that, in the optical transmission system according to the sixth embodiment, the m signal strings (z₁(t+τ₁), z₂(t+τ₂), . . . , and zₘ(t+τₘ)) are brought closer to the m signal strings (y₁(t), y₂(t), . . . , and yₘ(t)) in the transmission-side digital signal processing device 100 by an action of the phase adjusting unit 694. In other words, this action brings a trajectory of z₁(t+τ₁), z₂(t+τ₂), . . . , and zₘ(t+τₘ) in the m-dimensional partial space closer to a trajectory of y₁(t), y₂(t), . . . , and yₘ(t) in the m-dimensional partial space. That is, this action improves restoration accuracy in system number restoration processing by multiplication operation of the matrix W in the system number restoring unit 650.

As described above, since the optical transmission system according to the sixth embodiment acts as described above, in addition to the effect described in the first embodiment, the effect of improving the restoration accuracy in the system number restoration processing by the multiplication operation of the matrix W in the system number restoring unit 650 is obtained.

The optical transmission system according to the present disclosure technology is not limited to the aspects exemplified in the embodiments, and it is possible to combine the embodiments, to modify any component of each embodiment, or to omit any component in each embodiment.

### INDUSTRIAL APPLICABILITY

The present disclosure technology can be applied to, for example, a mobile fronthaul (MFH) of a centralized radio access network (C-RAN) considered to be promising in a next-generation mobile network, and has industrial applicability.

### REFERENCE SIGNS LIST

100: transmission-side digital signal processing device (transmission-side digital signal processor), 120: frequency-division multiplexing unit, 121: upsampler, 122: digital filter, 123: NCO, 124: multiplier, 125: adder, 150: system number compressing unit (system number compressor), 160: parameter updating unit (parameter updater), 170: parameter convergence determining unit (parameter convergence determiner), 180: modulation signal generating unit (modulation signal generator), 190: PILOT signal generating unit (PILOT signal generator), 200: DAC, 300: analog optical transmitter, 400: analog optical receiver, 500: ADC, 600: reception-side digital signal processing device (reception-side digital signal processor), 610: frequency-division demultiplexing unit, 611: downsampler, 612: digital filter, 613: NCO, 614: multiplier, 650: system number restoring unit (system number restorer), 680: demodulation processing unit (demodulation processor), 692: phase adjustment value calculating unit, 694: phase adjusting unit (phase adjustor), 710: transmission-side input interface, 720: transmission-side processing circuit, 722: transmission-side processor, 724: transmission-side memory, 730: transmission-side output interface, 810: reception-side input interface, 820: reception-side processing circuit, 822: reception-side processor, 824: reception-side memory, 830: reception-side output interface.

What is claimed is:

1. An IFoF scheme optical transmission system comprising
a transmission-side digital signal processor including a system number compressor and a parameter updater, and
a reception-side digital signal processor including a system number restorer,
wherein,
the system number compressor compresses n digital data streams into m digital data streams, m being smaller than n, and
the parameter updater updates a parameter used by the system number compressor by referring to a value of an evaluation function using a signal string handled by the transmission-side digital signal processor as an argument,
the system number restorer restores n digital data streams compressed into m digital data streams by referring to the parameter updated by the parameter updater,
the parameter updated by the parameter updater is a matrix (W^{H}) having a size of m×n and a matrix (W) obtained by performing Hermitian transpose on the matrix (W^{H}).

2. The IFoF scheme optical transmission system according to claim 1, wherein
the transmission-side digital signal processor further includes a parameter convergence determiner, and
the parameter convergence determiner determines whether the parameters have converged by referring to difference between the value of the evaluation function at one previous sampling time (k−1) and the value of the evaluation function at the current sampling time (k).

3. The IFoF scheme optical transmission system according to claim1, wherein
the transmission-side digital signal processor further includes a modulation signal generator,
the modulation signal generator converts the parameter into a modulation signal,
the reception-side digital signal processor further includes a demodulation processor, and
the demodulation processor demodulates the modulation signal into the parameter.

4. The IFoF scheme optical transmission system according to claim 1, wherein
the transmission-side digital signal processor further includes a PILOT signal generator,
the PILOT signal generator generates a multi-tone sin wave as a PILOT signal,
the reception-side digital signal processor further includes a phase adjustor, and
the phase adjustor performs temporal transition correction of the signal string by referring to the PILOT signal.

5. The IFoF scheme optical transmission system according to claim 1, comprising:
a transmission-side input interface; a transmission-side processor; a transmission-side memory; and a transmission-side output interface, wherein
each function of the transmission-side digital signal processor is implemented by software, firmware, or a combination of the software and the firmware, and is described as a program,
the program is stored in the transmission-side memory, and
the program is executed by the transmission-side processor, so that each function of the transmission-side digital signal processor is executed.

6. The IFoF scheme optical transmission system according to claim 1, comprising:
a reception-side input interface; a reception-side processor;
a reception-side memory; and a reception-side output interface, wherein
each function of the reception-side digital signal processor is implemented by software, firmware, or a combination of the software and the firmware, and is described as a program,
the program is stored in the reception-side memory, and
the program is executed by the reception-side processor, so that each function of the reception-side digital signal processor is executed.
